(19) United States
(12) Patent Application Publication
(10) Pub. No.: US 2002/0056996 A1
(43) Pub. Date: May 16, 2002

(54) Vehicle door lock apparatus

(76) Inventors: Katsutoshi Fukunaga, Chiryu-shi (JP); Makoto Suzumura, Kariya-shi (JP); Ryujiro Akizuki, Kariya-shi (JP); Norio Konomoto, Nagoya-shi (JP); Akira Muramatsu, Chiryu-shi (JP); Shigeru Hayakawa, Chiryu-shi (JP); Yasuhiko Sono, Hekinan-shi (JP)

Correspondence Address: Platon N. Mandros, Esquire, BURNS, DOANE, SWECKER & MATHIS, L.L.P., P.O. Box 1404, Alexandria, VA, 22313-1404, US

(21) Appl. No.: 09/983,902

(22) Filed: Oct. 26, 2001

(30) Foreign Application Priority Data
Oct. 26, 2000 (JP) 2000-327319

(51) Int. Cl. E05C 3/06

(52) U.S. Cl. 292/216

(57) ABSTRACT

A vehicle door lock apparatus includes a first body and a second body integrated so as to be adapted to be integrally assembled to the door. The vehicle door lock apparatus further includes guide projections formed at one of the first and second bodies, and guide grooves formed at the other of the first and second bodies. In addition, a stopper is provided for preventing the separation of integrated first and second bodies by the engagement between the guide projections and the guide grooves.

This application is based on and claims priority under 35 U.S.C. §119 with respect to Japanese Application 2000-327319 filed on Oct. 26, 2000, the entire content of which is incorporated herein by reference.

### FIELD OF THE INVENTION

This invention generally relates to a door lock. More particularly, the present invention pertains to a vehicle door lock apparatus.

### BACKGROUND OF THE INVENTION

A known vehicle door lock apparatus is disclosed in Japanese Patent Publication No. 2516432 published on Jul. 24, 1996. The disclosed vehicle door lock apparatus is formed with a first body accommodating a latch mechanism which includes a latch for opening and closing the vehicle door through engagement with a striker provided at the vehicle-body side and a pawl for restricting rotation of the latch through engagement of the pawl with the latch. The vehicle door lock apparatus is also formed with a second body accommodating an operation mechanism which activates the pawl. The first body is integrated with the second body so as to be integrally assembled to the door.

In the vehicle door lock apparatus disclosed in the publication mentioned above, the first body and the second body are configured to be integrated by a connecting member (e.g., a screw or a pin fixed by riveting). This construction thus requires additional parts as well as assembly work and time, thus leading to increased cost.

A need thus exists for a vehicle door lock apparatus that can be manufactured less expensively than other known door lock apparatus such as described above.

A need also exists for a vehicle door lock apparatus in which the first and second bodies are integrated in a way that does not require the same number of components as other known apparatus and does not require the same degree of assembly work as other known apparatus.

### SUMMARY OF THE INVENTION

According to an aspect of the present invention, a vehicle door lock apparatus includes a first body having a body and a base plate, a latch mechanism accommodated between the body and the base plate, with the latch mechanism including a latch adapted to engage a striker on the vehicle and a pawl for restricting rotation of the latch through engagement of the pawl with the latch, a second body having a housing main body and a cover connected to the housing main body, and an operation mechanism accommodated between the housing main body and the cover to activate the pawl. A guide projection is provided at one of the first body and the second body, and a guide groove is provided at the other one of the first body and the second body, with the guide projection engaging the guide groove so that the first and second bodies are integrated with one another. A stopper is also provided between the first body and the second body for preventing separation of the first and the second bodies.

According to another aspect of the invention, a vehicle door lock apparatus includes a first body accommodating a latch mechanism which includes a latch for effecting opening and closing of a vehicle door through engagement with a striker provided at a vehicle-body side and a pawl for restricting rotation of the latch through engagement of the pawl with the latch, and a second body accommodating an operation mechanism which activates the pawl. The first body is integrated with the second body for being integrally assembled to the vehicle door. A guide projection is formed at one of the first body and the second body, and a guide groove is formed at the other one of the first body and the second body, with the guide groove being engaged with the guide projection. A stopper is provided between the first body and the second body for preventing separation of the integrated first and the second bodies by the engagement between the guide projection and the guide groove.

As compared to a door lock apparatus employing a connecting member to integrate the first body and the second body, the number of components used in the door lock apparatus of the present invention is reduced and the assembly of the apparatus is made easier. Thus, the cost associated with manufacturing the door lock apparatus can be reduced.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a side view of the interior of a vehicle door lock apparatus provided within a door and viewed from the vehicle-body side according to the present invention.

FIG. 2 is a rear view of the vehicle door lock apparatus shown in FIG. 1 viewed from the rear side of the door.

FIG. 3 is a plan view of the vehicle door lock apparatus shown in FIG. 1 viewed from above.

FIG. 4 is an exploded perspective view of the vehicle door lock apparatus shown inn FIG. 1.

FIG. 5 is a side view showing how components of the vehicle door lock apparatus operate under the unlocked state.

FIG. 6 is a side view showing how components of the vehicle door lock apparatus operate under the locked state.

FIG. 7 is a side view showing how components of the vehicle door lock apparatus operate under the locked state with a one-motion operation being conducted.

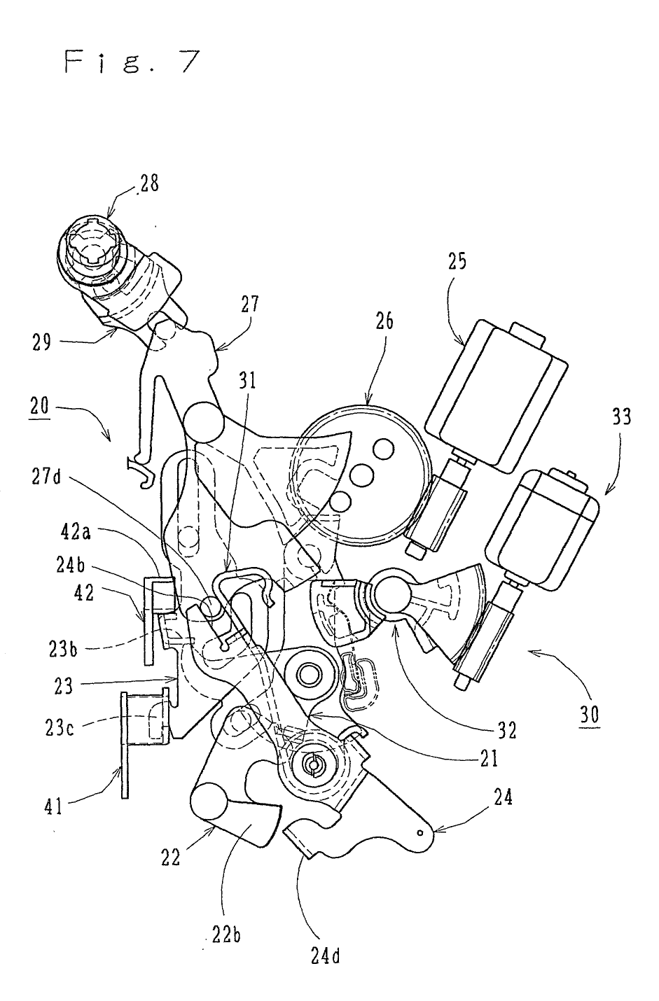

FIG. 8 is a side view showing how components of the vehicle door lock apparatus operate under the double-locked state.

FIG. 9 is an exploded view of the door lock apparatus before a first body and a second body of the vehicle door lock apparatus are integrated.

FIG. 10 is a front view of the first body shown in FIG. 9.

FIG. 11 is a rear view of the first body shown in FIG. 9.

FIG. 12 is a bottom view of the first body shown in FIG. 9.

FIG. 13 is a vertical cross-sectional side view of the first body and the second body integrated with one another.

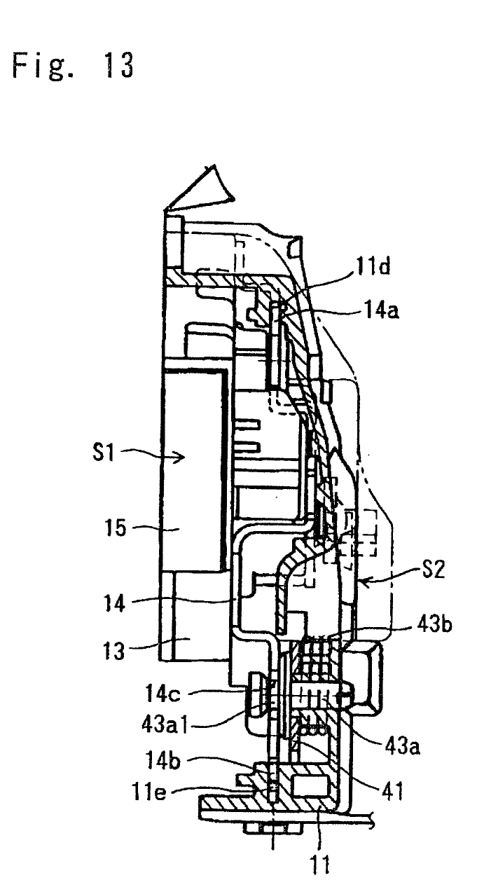

### DETAILED DESCRIPTION OF THE INVENTION

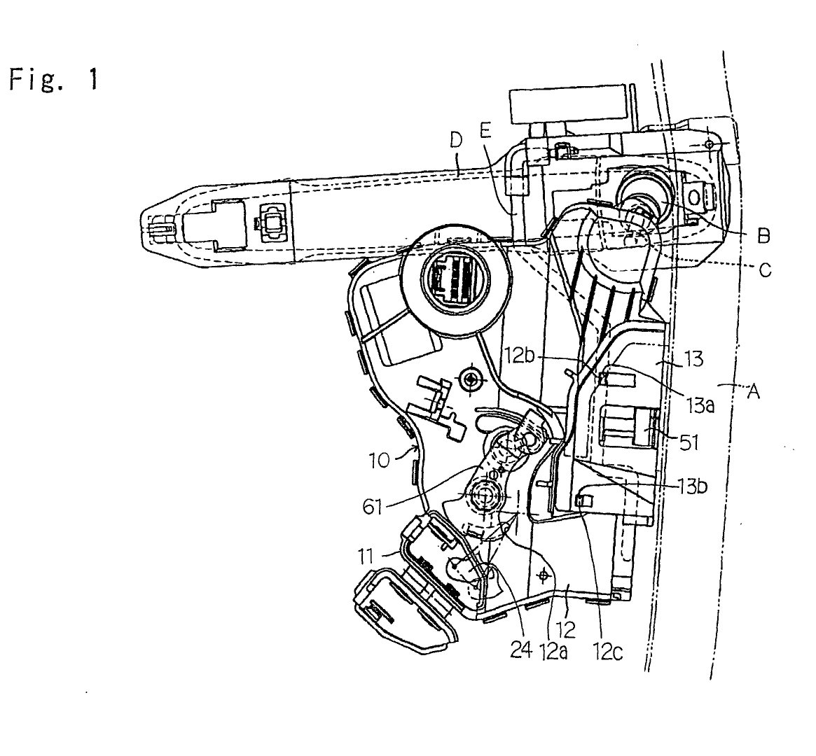

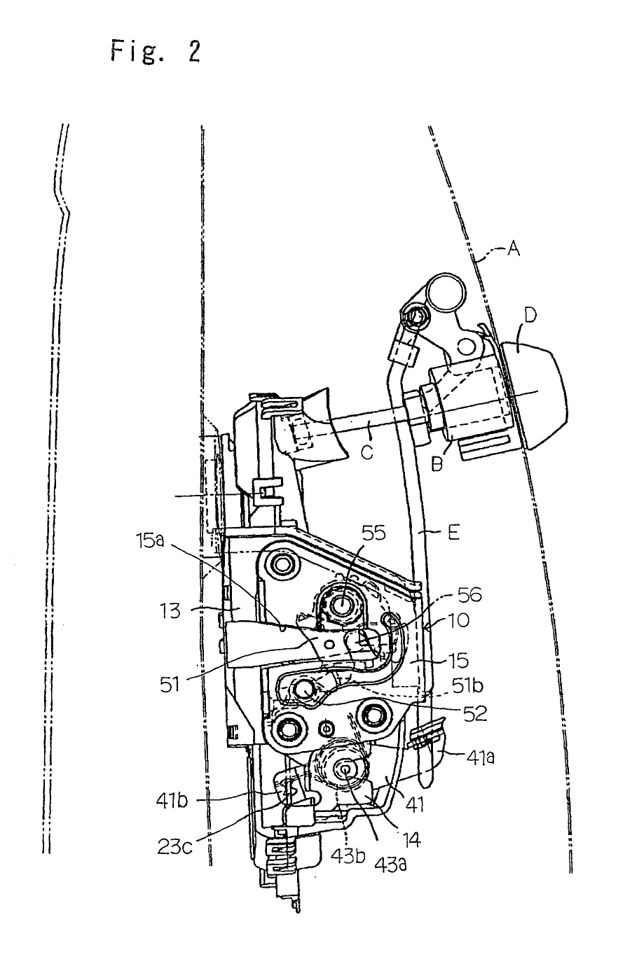

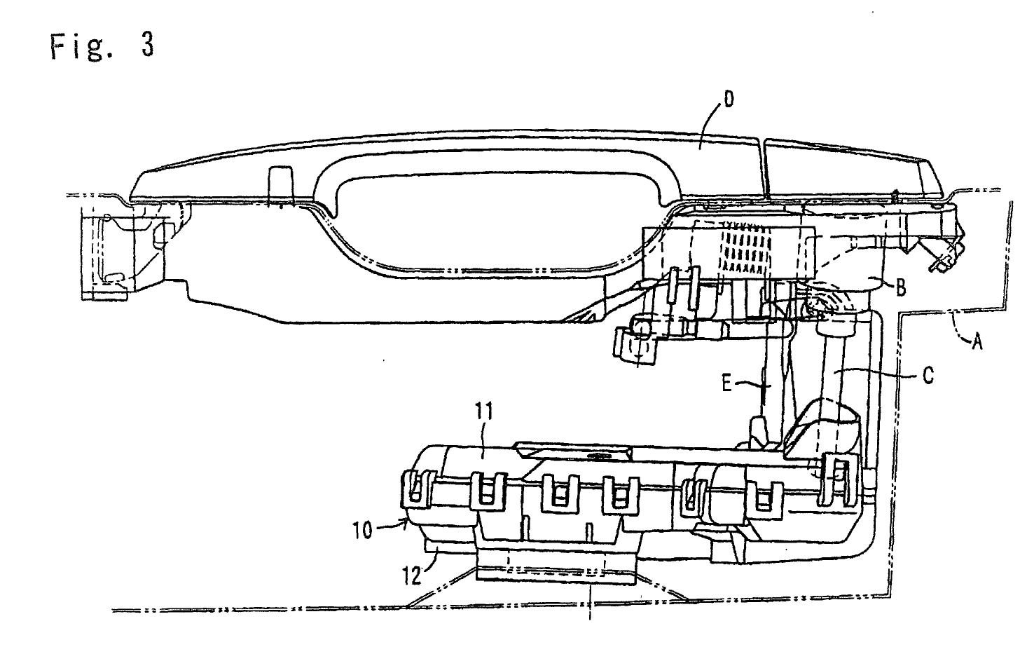

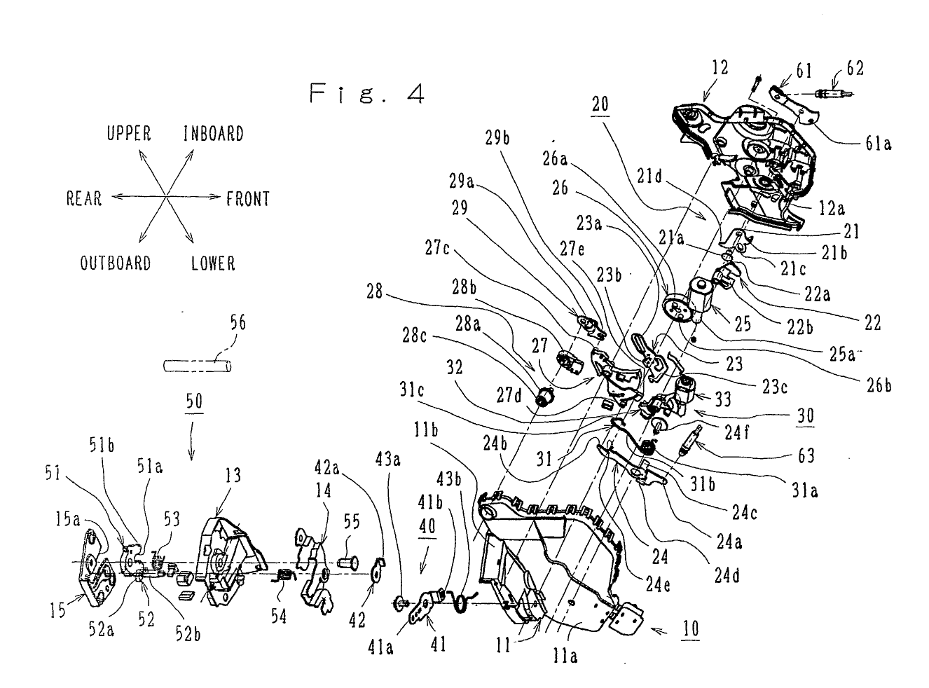

Referring to FIG. 1 which is an inside view of the vehicle door lock apparatus of the present invention provided within a door A and viewed from the vehicle-body side and FIGS. 2-4, the door lock apparatus includes a housing 10 in which a first operation mechanism 20, a second operation mechanism 30, and a third operation mechanism 40 are accommodated. The door lock apparatus also includes a body 13 in which a latch mechanism 50 is accommodated. The arrows in FIG. 4 indicate the front and rear of the vehicle, the upper and lower directions, and the inboard and outboard sides of the vehicle body.

The housing 10 of the door lock apparatus is provided with a resinous housing main body 11, a resinous cover 12, and a resinous body 13. The housing main body 11 includes a dish-shaped first case portion 11a which opens to the inside, and a dish-shaped second case portion 11b which extends perpendicularly to the first case portion 11a and opens rearward. The open side of the first case portion 11a is coupled with the cover 12 to close the open side of the first case portion 11a, and the open side of the second case portion 11b is coupled with the body 13 together with a sub base plate 14 and a base plate 15 to close the open side of the second case portion 11b.

As shown in FIG. 4, the components of the first operation mechanism 20 and the second operation mechanism 30 are provided inside an interior portion defined between the first case portion 11a of the housing main body 11 and the cover 12. Similarly, the sub base plate 14 and the components of the third operation mechanism 40 are provided inside an interior portion defined between the second case portion 11b of the housing main body 11 and the body 13. A rear open portion of the body 13 is coupled with the base plate 15 to close the open portion. The components of the latch mechanism 50 are provided inside an interior portion defined between the body 13 and the base plate 15.

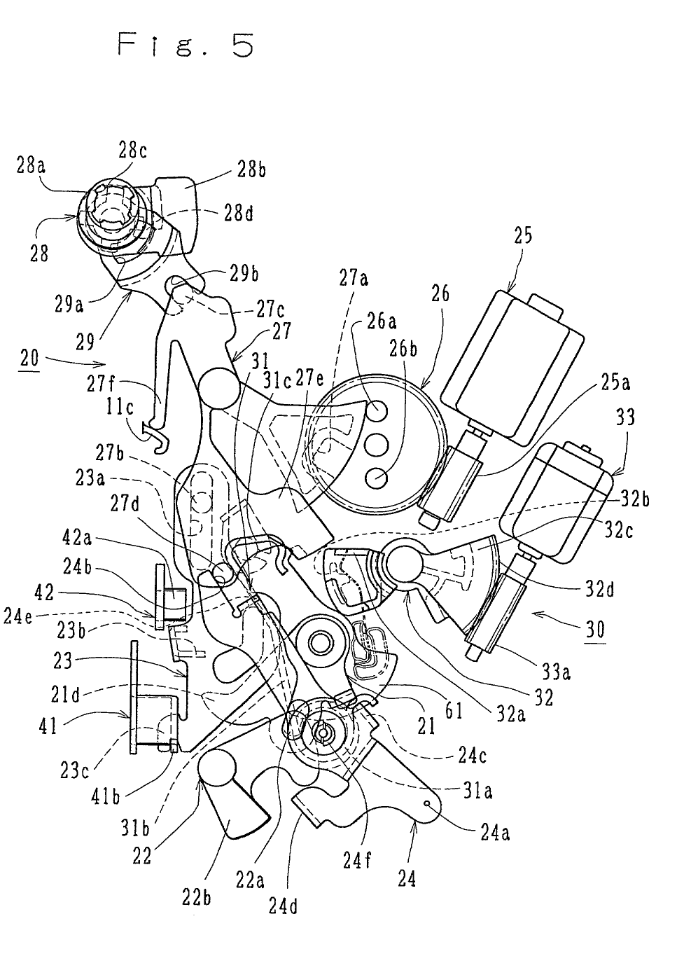

As shown in FIGS. 4 and 5, the first operation mechanism 20 is provided with a first inside lever 21, a second inside lever 22, an open link 23, a lock operation lever 24, a first electric motor 25, a wheel gear 26, an active lever 27, a key lever 28, and an idle lever 29. FIG. 5 shows each component of the first operation mechanism 20 and the second operation mechanism 30 viewed from outside the vehicle.

The first inside lever 21 is rotatably assembled inside the cover 12 via a support pin 21a. A third inside lever 61 is rotatably assembled outside the cover 12 via the common support pin 21a. The first inside lever 21 is provided with an engaging projection 21b extending toward the cover 12. The engaging projection 21b extends completely through an arc-shaped hole 12a of the cover 12 and is engaged with a connecting hole 61a of the third inside lever 61. As a result, the first inside lever 21 and the third inside lever 61 are connected together as a unit. The third inside lever 61 is connected with one end of an inside cable 62 (specifically an inner wire) whose other end is connected with an inside handle (not shown) provided at the vehicle-body side of the door A. By manipulating the inside handle in the open direction (i.e., an opening operation of the inside lever), the third inside lever 61 is rotated in the clockwise direction of FIG. 5 and causes the first inside lever 21 to rotate in the clockwise direction.

The second inside lever 22 is rotatably assembled inside the cover 12 and is placed outside the first inside lever 21. The second inside lever 22 is provided with an engaging pin 22a extending toward the cover 12, and an engaging arm portion 22b placed at the side of the housing main body 11. By inserting the engaging pin 22a into a slot 21c of the first inside lever 21, the second inside lever 22 is connected with the first inside lever 21.

The open link 23 placed outside the first inside lever 21 is provided with an elongated engaging slot 23a through which a first engaging pin 27b of an active lever 27 (described in more detail below) is inserted, an L-shaped engaging portion 23b with which a tip portion 21d of the first inside lever 21 is in contact and in engagement, and a connecting portion 23c adapted to be connected to an open lever 41 which will be described in more detail below. The open link 23 is supported by the active lever 27 and the open lever 41.

The lock operation lever 24 is rotatably assembled inside the first case portion 11a of the housing main body 11. The lock operation lever 24 is provided with a mounting hole 24a to which is secured a locking cable 63, a receiving portion 24b for receiving a third engaging pin 27d of the active lever 27, an engaging portion 24c for engaging one end of an engaged lever 31, and a contacting portion 24d with which a tip portion of the engaging arm portion 22b of the second inside lever 22 is in contact. The locking cable 63 (i.e., the inner wire) is connected with a lock knob (not shown) provided at the vehicle-body side of the door A and is also connected with the lock operation lever 24 via the mounting hole 24a. When the lock knob is operated to be locked, the locking cable 63 transmits the operation force of the lock knob to the lock operation lever 24 and rotates the lock operation lever 24 in the clockwise direction of FIG. 5. When the lock knob is operated to be unlocked, the locking cable 63 transmits the operation force of the lock knob to the lock operation lever 24 and rotates the lock operation lever 24 in the counterclockwise direction of FIG. 5.

The first electric motor 25 functions to output an operation force for driving the first operation mechanism 20. The first electric motor 25 is mounted inside the cover 12 and is provided with a worm 25a which is integrally assembled on an output shaft of the first electric motor 25. The worm 25a is in meshing engagement with a gear portion of the wheel gear 26. The first electric motor 25 is under remote control operation of a lock/unlock switch (lock/unlock operation) provided in each of a key blade and a door-inside trim. The wheel gear 26, which functions as an output portion of the first electric motor 25, includes a pair of engaging pins 26a, 26b at the outer side. The wheel gear 26 is rotatably supported by the first case portion 11a and the cover 12. The engaging pins 26a, 26b are placed on a common circumference keeping a predetermined space therebetween and are opposed to each other with respect to the rotation axis of the wheel 26. When the wheel gear 26 is rotated in one direction, one of the engaging pins 26a is brought into contact with a sector portion of the active lever 27, and the other one of the engaging pins 26b is moved into an engaging concavity 27a. When the wheel gear 26 is rotated in the opposite direction, one of the engaging pins 26a is brought into disengagement from the sector portion of the active lever 27 while the other one of the engaging pins 26b is moved out of the engaging concavity 27a.

The active lever 27 is rotatably supported by the first case portion 11a and the cover 12, and is placed between the open link 23 and the lock operation lever 24. The active lever 27 includes the engaging concavity 27a (shown in FIG. 5), the first engaging pin 27b (shown in FIG. 5), and a second engaging pin 27c which face the cover 12. The active lever 27 also includes the third engaging pin 27d and a projection portion 27e which face the first case portion 11a. The active lever 27 further includes an arm 27f being engaged with the projection piece 11c formed at the housing main body 11 in an elastic manner.

With respect to the active lever 27, the engaging concavity 27a is opposed to the wheel gear 26, and the first engaging pin 27b is inserted into the engaging slot 23a of the open link 23. The second engaging pin 27c is engaged with a second engaging slot 29b of the idle lever 29, and the third engaging pin 27d is received in the receiving portion 24b of the lock operation lever 24. The projection portion 27e is disposed adjacent to an output lever 32. In addition, when the wheel gear 26 is rotated in one direction or the other direction, either the pin 26a or the pin 26b is selectively moved into or from the engaging concavity 27a of the active lever 27 to be engaged or disengaged therewith, and the active lever 27 is selectively rotated in the clockwise direction or the counterclockwise direction of FIG. 5.

The key lever 28 is provided with a column-shaped or bar-shaped main body 28a and a lever portion 28b integrally formed therewith. The key lever 28 is rotatably supported together with the idle lever 29 by the first case portion 11a of the housing main body 11. The column-shaped main body 28a includes a groove 28c into which the tip portion of a rod C is disposed, The rod C extends from a key cylinder B (shown in FIGS. 1-3) and transmits torque. An engaging pin 28d (shown in FIG. 5) is formed at the rear side of the lever portion 28b for being inserted into an arc-shaped first engaging slot 29a provided at the idle lever 29.

A tip portion of the idle lever 29 is formed with the second engaging slot 29b which opens at the tip. The second engaging pin 27c of the active lever 27 is inserted into the second engaging slot 29b. The key lever 28, which is rotated when the key cylinder B is rotated by operating a key or key blade, causes the idle lever 29 to rotate selectively in the clockwise direction and the counterclockwise direction of FIG. 5 and causes, by way of the idle lever 29, selective rotation of the active lever 27 in the clockwise direction and the counterclockwise direction of FIG. 5.

The second operation mechanism 30 is provided with the engaged lever 31, the output lever 32, and a second electric motor 33. The engaged lever 31 is formed of a wire steel spring, or other elastic wire materials, and includes a coil-shaped base portion 31a, a lever portion 31b extending from the base portion 31a over a predetermined length, and a hook-shaped engaged portion 31c formed at the tip portion of the lever portion 31b. With the base portion 31a of the engaged lever 31 being wound around a support pin 24f which rotatably supports the lock operation lever 24, one end of the base portion 31a is engaged with the engaging portion 24c of the lock operation lever 24, and an intermediate portion of the lever portion 31b is engaged with an engaging portion 24e of the lock operation lever 24. The engaged lever 31 is assembled to the lock operation lever 24 to be operated therewith with the lever portion 31b being biased in the counterclockwise direction of FIG. 5. At the rear side of the tip portion of the lever portion 31b, the third engaging pin 27d of the active lever 27 is received by the engaged lever 31 and the receiving portion 24b of the lock operation lever 24.

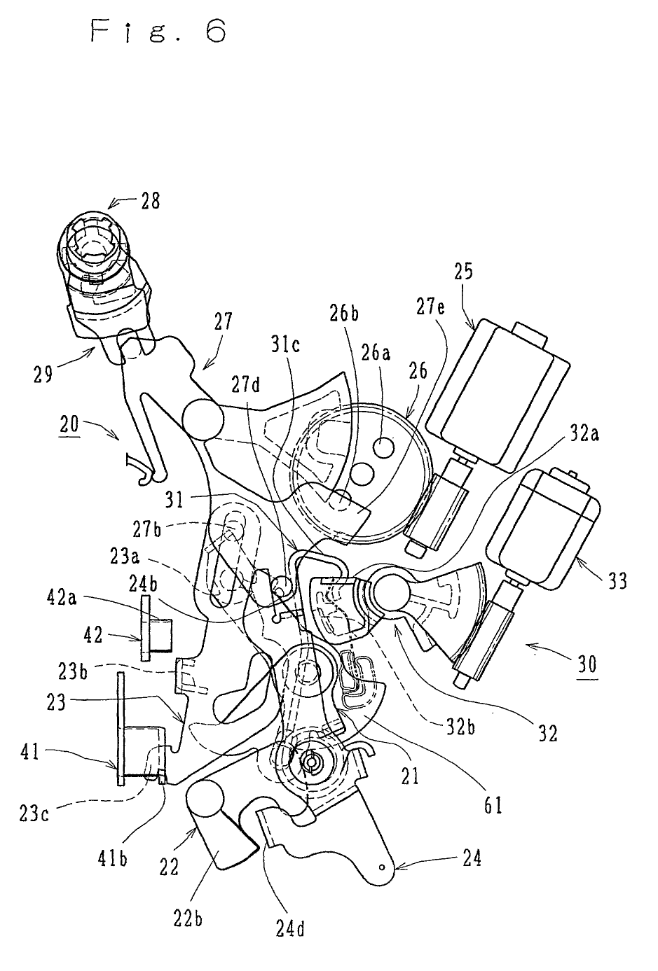

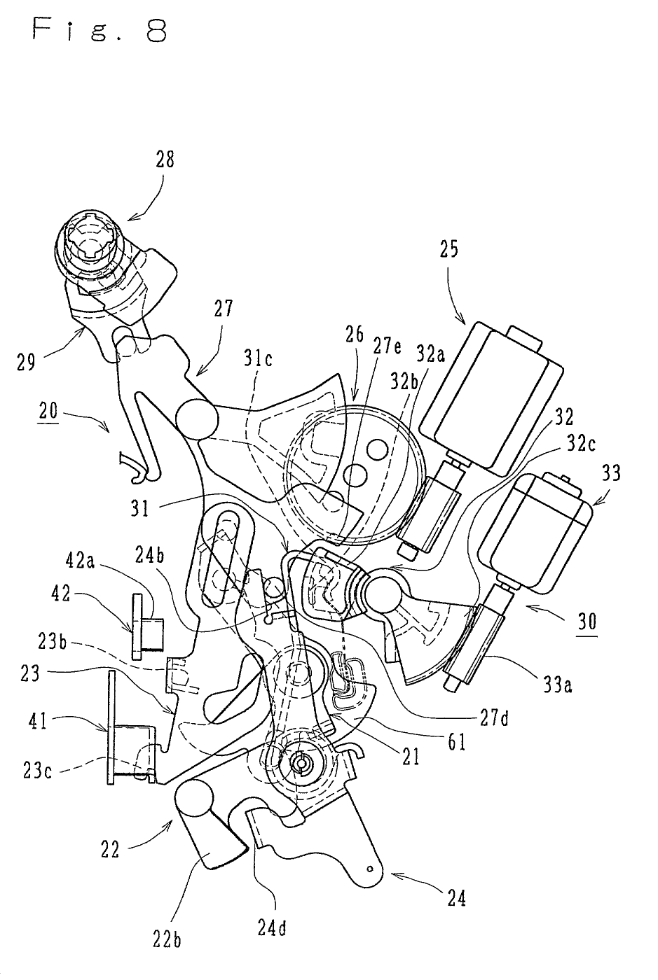

The output lever 32 is rotatably assembled to the first case portion 11a and the cover 12. As shown in FIG. 5, the tip portion of a first swing arm portion 32a, disposed at one side of the output lever 32, is formed with an engaging portion 32b, and the periphery of the tip portion of a second swing arm portion 32c, disposed at the other side of the output lever 32, is formed with an arc-shaped gear portion 32d. The second electric motor 33 rotates the output lever 32 by a worm 33a mounted on an output shaft of the second electric motor 33 which meshes with the gear portion 32d of the output lever 32. The second electric motor 33 is under remote control operation (set/reset operation) of a double-lock switch provided in each of the key or key blade and the door-inside trim. When the engaged lever 31 is being moved into the double-lock operation position from the locked state shown in FIG. 6 and the output lever 32 is rotated in the clockwise direction by the second electric motor 33 being operated to produce an output rotation in the normal direction, the output lever 32 retains the engaged lever 31 in such a manner that the engaging portion 32b of the first swing arm portion 32a is brought into engagement with the engaged portion 31c of the engaged lever 31 as shown in FIG. 8.

The engagement state of the output lever 32 and the engaged lever 31 (i.e., the double-locked state) is released when the output lever 32 is rotated in the counterclockwise direction. Such a rotation of the output lever 32 can be established by transferring the active lever 27 to its unlock operation position in addition to reversing the second electric motor 33. When the output lever 32 is engaged with the engaged lever 31 (at a set position), the active lever 27 is shifted to the lock operation position as shown in FIG. 8, and the projection portion 27e of the active lever 27 is disposed adjacent to the upper side of the first swing arm portion 32a of the output lever 32. Accordingly, by rotating the active lever 27 in the clockwise direction, the projection portion 27e of the active lever 27 is brought into contact with the upper end portion of the first swing arm portion 32a of the output lever 32 to urge the first swing arm portion 32a downward. Then the output lever 32 is rotated through an angle in the counterclockwise direction which results in the engagement of the output lever 32 and the engaged lever 31 being released as shown in FIG. 6 (at the rest position).

Each component of the third operation mechanism 40 is provided between the second case portion 11b of the housing main body 11 and the body 13. The third operation mechanism 40 includes the open lever 41 and a lift lever 42. The open lever 41 is rotatably supported by a resinous support pin 43a and a torsion spring 43b between the second case portion 11b and the sub base plate 14. One rotation end portion 41a of the open lever 41 is connected with an outside link E which is in association with an outside handle D provided at the vehicle-outboard side of the door A, while the other rotation end portion 41b is connected with the connecting portion 23c of the open link 23. The open lever 41 is rotated to move the rotation end portion 41b upward against the force of the torsion spring 43b when the outside handle D is operated in an opening operation (opening operation in the vehicle-outboard direction). The lift lever 42 is fixedly mounted on a shaft portion 52b of a pawl 52 extending through the body 13. As shown in FIG. 5, an engaging piece 42a formed at a periphery of the lift lever 42 is placed above the upper end of the engaging portion 23b of the open link 23.

The latch mechanism 50 includes a latch 51, the pawl 52, a pair of torsion springs 53, 54 biasing the latch 51 and the pawl 52 respectively, and three rubber cushions shown in FIG. 4. The latch 51, the torsion spring 53 for biasing the latch 51, and a main body 52a of the pawl 52 are provided, together with the three rubber cushions, inside the body 13 between the body 13 and the base plate 15.

The latch 51 is rotatably supported between the body 13 and the base plate 15 by a support pin 55 which extends completely through the sub base plate 14, the body 13, and the base plate 15 and is supported thereby. One end of the torsion spring 53, which is coaxially assembled on the support pin 55, is engaged with the latch 51. The other end of the torsion spring 53 is engaged with the body 13 for restricting the rotation of the latch 51 with a predetermined force and for biasing the latch 51 to return when the latch 51 is rotated. The latch 51 is maintained by the torsion spring 53 in order that an opening portion of an engaging groove 51a is approximately matched with an opening portion of an insert groove 15a provided at the base plate 15.

The pawl 52 is provided with the block-shaped main body 52a and the shaft portion 52b extending therefrom perpendicularly. The shaft portion 52b which extends completely through the body 13 and the sub base plate 14 terminates in an inner space of the second case portion 11b of the housing main body 11 and is rotatably supported by the sub base plate 14 and the base plate 15. The torsion spring 54 placed between the body 13 and the sub base plate 14 for biasing the pawl 52 is coaxially assembled around the shaft portion 52b of the pawl 52. A tip portion of the shaft portion 52b is fitted with the lift lever 42 (e.g., through a riveted fixation) so as to be rotated as one unit. One end of the torsion spring 54 is engaged with the pawl 52 and the other end of the torsion spring 54 is engaged with the sub base plate 14. The torsion spring 54 restricts the rotation of the pawl 52 with a predetermined force and biases the pawl 52 to return when the pawl 52 is rotated. The main body 52a of the pawl 52 is in contact with the outside periphery of the latch 51.

When a striker 56 provided at a vehicle-body side enters through the insert groove 15a of the base plate 15, the latch 51 receives the striker 56 and is rotated by the pushing operation of the striker 56 against the force of the torsion spring 53. Meanwhile, the pawl 52 is in sliding engagement with an outer surface of the latch 51 to be engaged with an engaging portion 51b as shown in FIG. 2. Thus, the latch 51 is held by the pawl 52 in a rotated state receiving the striker 56. The striker 56 is engaged with the latch 51 and the engaging state is maintained. Under this state, the door is in the closed state.

The latch 51 is biased to return by the torsion spring 53 in the engaging state. When the pawl 52 is rotated to be removed or separated from the engaging portion 51b of the latch 51 due to the rotation of the lift lever 42, the latch 51 is returned by the biasing force of the torsion spring 53. The opening portion of the engaging groove 51a is rotated to be matched with the opening portion of the insert groove 15a of the base plate 15. Under this state, the striker 56 is movable through the engaging groove 51a of the latch 51 and the insert groove 15a of the base plate 15. Accordingly, the door is ready to open in this state. The pawl 52 functions to selectively establish the engaging state and the disengaging state between the latch 51 and the striker 56. When the pawl 52 is rotated against the force of the torsion spring 54, the pawl 52 is disengaged from the engaging portion 51b of the latch 51, and then the engaging state between the latch 51 and the striker 56 is released.

With the door lock apparatus constructed as described above, the following operations can be obtained: an operation establishing a locked state under which the engagement between the latch 51 and the striker 56 cannot be released; an operation establishing an unlocked state under which the engagement between the latch 51 and the striker 56 can be released; an operation which is performed for opening and closing the door under the unlocked state; an operation which is performed for opening and closing the door under the locked state (i.e., one-motion operation); an operation establishing a double-locked state under which the locked state cannot be varied or moved to the unlocked state; and an operation releasing the double-locked state. A detailed explanation of the operations is not included here as they are known to those in the art.

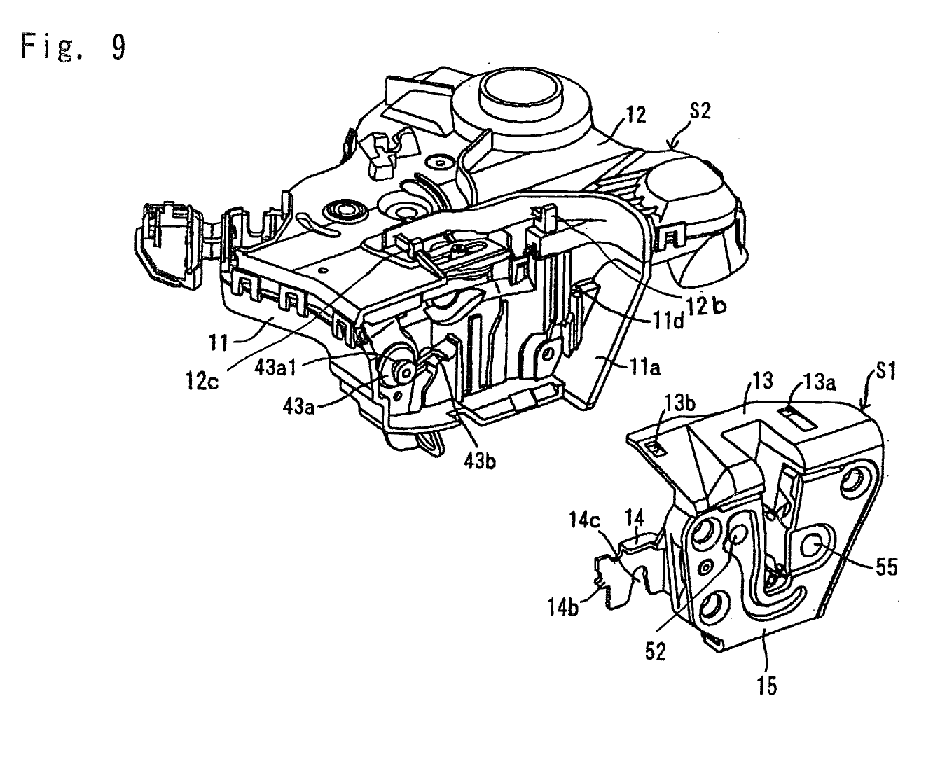

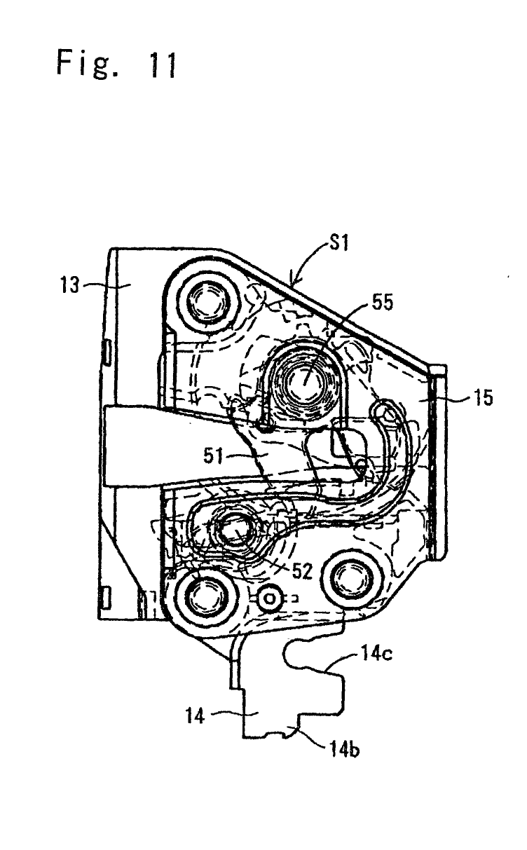

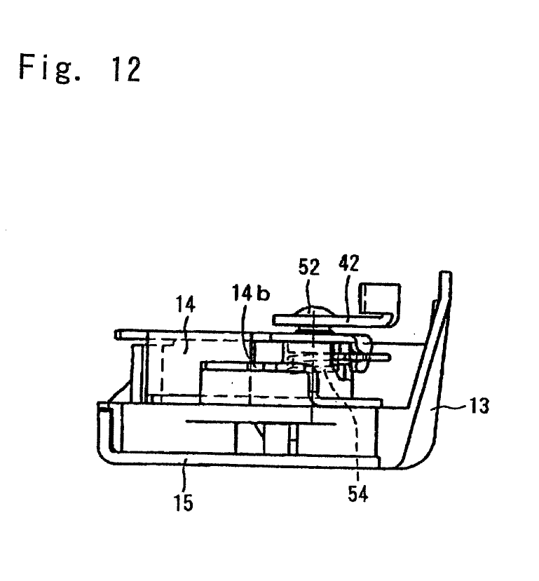

According to the above embodiment of the present invention, components such as the latch 51, the torsion spring 53 for biasing the latch 51, the pawl 52, the torsion spring 54 for biasing the pawl 52, the support pin 55, the lift lever 42, and the three rubber cushions as shown in FIG. 4 are assembled to a first body S1 which is provided by the body 13, the sub base plate 14, and the base plate 15. All of the components are integrally formed in advance as shown in FIGS. 9-12.

Meanwhile, the other components (components of the first operation mechanism 20 and the second operation mechanism 30, the open lever 41 of the third operation mechanism 40, the resinous support pin 43a, the torsion spring 43b, and the third inside lever 61) excluding the above described components are assembled to a second body S2 which is provided by the housing main body 11 and the cover 12. All components are integrally formed in advance as shown in FIG. 9.

With the first body S1 and the second body S2 shown in FIG. 9 being integrally formed as shown in FIGS. 1-3 by assembling the first body S1 to the second body S2, the combination thereof is assembled to the door A with three installing bolts (not shown). In order to integrate the first body S1 and the second body S2, a pair of guide projections 14a, 14b are integrally formed at the sub base plate 14 which comprises the first body S1, and a pair of guide grooves 11d, 11e are integrally formed at the housing main body 11 which comprises the second body S2. The guide grooves 11d, 11e are slidably engaged with the guide projections 14a, 14b respectively. When the door lock apparatus of the present invention is assembled to the door A as shown in FIGS. 1-3 and the door A is closed, the guide grooves 11d, 11e and the guide projections 14a, 14b extend inward and outward of the vehicle. The number of guide projections 14a, 14b and guide grooves 11d, 11e can be appropriately adjusted.

The sub base plate 14 is integrally formed with an engaging groove 14c (having an engaging hole which can be engaged with an engaging shaft portion 43a1 at an end portion, and a throttle portion with slightly smaller width than the diameter of the engaging shaft portion 43a1) which can be engaged with the engaging shaft portion 43a1 formed at the resinous support pin 43a of the third operation mechanism 40. The engaging groove 14c functions together with the engaging shaft portion 43a1 as a stopper for preventing the separation of the integrated first and second bodies S1, S2. The engaging shaft portion 43a1 is enlarged relative to the engaging groove 14c. The cover 12 is integrally formed with a pair of projections 12b, 12c locating by being engaged with a pair of engaging square holes 13a, 13b provided at the body 13.

Accordingly, when the guide projections 14a, 14b are slidably engaged with the guide grooves 11d, 11e respectively, the projections 12b, 12c of the cover 12 are engaged with the engaging square holes 13a, 13b of the body 13 as shown in FIG. 1, while the engaging groove 14c of the sub base plate 14 is engaged with the engaging shaft portion 43a1 of the resinous support pin 43a to function as the stopper for preventing the separation of the integrated first and second bodies S1, S2. The number of stoppers can be appropriately adjusted.

In the embodiment of the present invention as described above, a pair of the guide projections 14a, 14b and the engaging groove 14c are integrally formed at the sub base plate 14. A pair of the guide grooves 11d, 11 e are integrally formed at the housing main body 11, and the engaging shaft portion 43a1 is integrally formed at the resinous support pin 43a. In addition, the integration of the first body S1 and the second body S2 can be effected or completed by both bodies S1, S2 being relatively moved and the stopper configured with the engaging groove 14c and the engaging shaft portion 43a1 prevents the separation of the integrated first body S1 and second body S2 achieved by the sliding engagement between the guide projections 14a, 14b and the guide grooves 11d, 11e. Accordingly, compared to a construction in which a connecting member is used for the integration of the first body S1 and the second body S2, the number of components can be reduced and the assembling work can be improved. Thus, the cost can be reduced.

In accordance with the present invention, with the door lock apparatus of the present invention being assembled to the door A and when the door A is closed, the guide grooves 11d, 11e are configured to be extended inward and outward of the vehicle. Thus when the vehicle is running, a load urging the engaging groove 14c and the engaging shaft portion 43a1 to be separated and affecting the engaging portion thereof is small. The engagement state of the engaging groove 14c and the engaging shaft portion 43a1 can thus be maintained for a long period.

In the above embodiment of the present invention, the guide projections 14a, 14b are provided at the first body S1, and the guide grooves 11d, 11e are provided at the second body S2. However, it is to be understood that the guide grooves can be provided at the first body and the guide projections provided at the second body. In addition, in the embodiment of the present invention, the stopper is configured with the engaging groove 14c formed at the sub base plate 14 comprising the first body S1 and the engaging shaft portion 43a1 formed at the resinous support pin 43a comprising the second body S2. However, other forms of the stopper can be appropriately configured and employed.

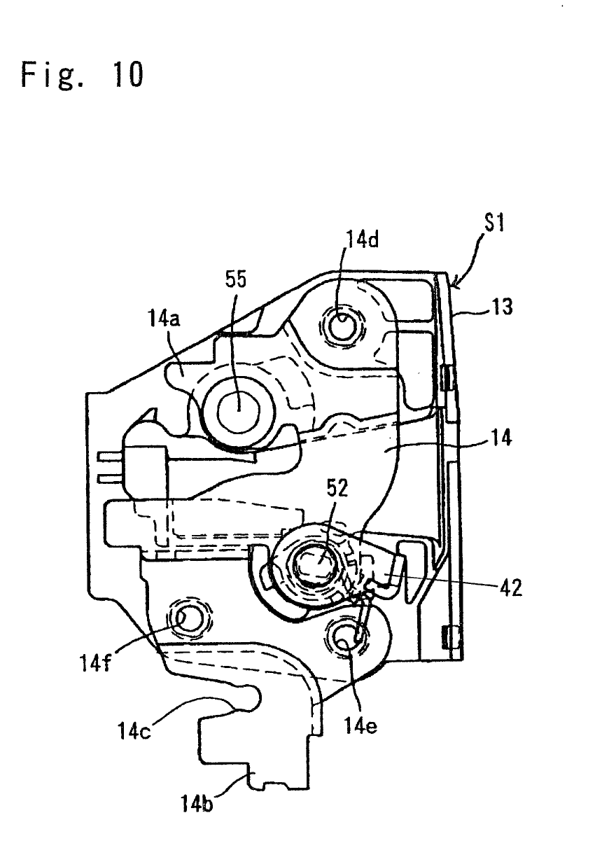

When the present invention is actually used in the door lock apparatus for an automobile with the first body S1 and the second body S2 being integrated, if at least one of the portions of the housing main body 11 corresponding to three tapped holes 14d, 14e, 14f (shown in FIG. 10) provided at the sub base plate 14 is formed with a concave portion (not shown), and the tip portion of an installing bolt (not shown) is configured to be engaged with the concave portion, the integrated state of the first body S1 and the second body S2 can be assured. In addition, the function of the stopper for preventing the separation of the second body S2 from the first body S1 can be reinforced.

In the embodiment of the present invention, the door lock apparatus includes the first operation mechanism 20, the second operation mechanism 30, and the third operation mechanism 40 provided at the housing 10. However, if the door lock apparatus is designed without the double-locked system, the second operation mechanism 30 might not be required. In this case, the receiving portion 24b provided at the lock operation lever 24 of the first operation mechanism 20 should possess an elongated shape where the third engaging pin 27d of the active lever 27 provided at the first operation mechanism 20 is inserted. Then the lock operation lever 24 and the active lever 27 are connected in such a manner that the engagement and the disengagement thereof are both impossible.

The principles, preferred embodiment and modes of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. A vehicle door lock apparatus comprising:
a first body including a body and a base plate;
a latch mechanism accommodated between the body and the base plate, the latch mechanism including a latch adapted to engage a striker on the vehicle and a pawl for restricting rotation of the latch through engagement of the pawl with the latch;
a second body including a housing main body and a cover connected to the housing main body;
an operation mechanism accommodated between the housing main body and the cover to activate the pawl;
a guide projection provided at one of the first body and the second body;
a guide groove provided at the other one of the first body and the second body, the guide projection engaging the guide groove so that the first and second bodies are integrated with one another; and
a stopper provided between the first body and the second body for preventing separation of the first and the second bodies.

2. The vehicle door lock apparatus according to claim 1, wherein the stopper includes an engaging groove provided on the first body and an engaging shaft portion mounted on the housing main body.

3. The vehicle door lock apparatus according to claim 1, including a plurality of guide projections formed at one of the first body and the second body, and a plurality of guide grooves formed at the other one of the first body and the second body, each guide groove being engaged with one of the guide projections.

4. The vehicle door lock apparatus according to claim 1, wherein the first body also includes a sub base plate that is separate from the body and the base plate, the base plate being positioned on one side of the body and the sub base plate being positioned on an opposite side of the body.

5. The vehicle door lock apparatus according to claim 4, wherein the guide projection is provided on the sub base plate.

6. The vehicle door lock apparatus according to claim 4, wherein the guide groove is provided on the housing main body.

7. The vehicle door lock apparatus according to claim 4, wherein the stopper includes an engaging groove formed on the sub base plate and a pin provided on the housing main body and engaged by the engaging groove.

8. The vehicle door lock apparatus according to claim 1, wherein the cover is provided with at least one projection that engages a hole provided in the body of the first body.

9. A vehicle door lock apparatus comprising:
a first body accommodating a latch mechanism which includes a latch for effecting opening and closing of a vehicle door through engagement with a striker provided at a vehicle-body side and a pawl for restricting rotation of the latch through engagement of the pawl with the latch;
a second body accommodating an operation mechanism which activates the pawl;
the first body being integrated with the second body for being integrally assembled to the vehicle door;
a guide projection formed at one of the first body and the second body, and a guide groove formed at the other one of the first body and the second body, the guide groove being engaged with the guide projection; and
a stopper provided between the first body and the second body for preventing separation of the integrated first and the second bodies by the engagement between the guide projection and the guide groove.

10. The vehicle door lock apparatus according to claim 9, wherein the stopper is comprised of an engaging groove provided at the first body and an engaging shaft portion provided at the second body.

11. The vehicle door lock apparatus according to claim 9, including a plurality of guide projections formed at one of the first body and the second body, and a plurality of guide grooves formed at the other one of the first body and the second body, each guide groove being engaged with one of the guide projections.

12. The vehicle door lock apparatus according to claim 9, wherein the first body includes a body, a base plate and a sub base plate, the latch mechanism being accommodated between the body and the base plate.

13. The vehicle door lock apparatus according to claim 12, wherein the guide projection is formed on the sub base plate.

14. The vehicle door lock apparatus according to claim 12, wherein the base plate is positioned on one side of the body and the sub base plate is positioned on an opposite side of the body.

15. The vehicle door lock apparatus according to claim 9, wherein the second body includes a housing main body and a cover connected to the housing main body.

16. The vehicle door lock apparatus according to claim 15, wherein the guide groove is formed on the housing main body.

17. The vehicle door lock apparatus according to claim 9, wherein the first body includes a body, a base plate and a sub base plate, and the second body includes a housing main body and a cover connected to the housing main body, the cover being provided with at least one projection that engages a hole provided in the body.

18. The vehicle door lock apparatus according to claim 17, wherein the base plate is positioned on one side of the body and the sub base plate is positioned on an opposite side of the body.
